(19) United States
(12) Patent Application Publication
(10) Pub. No.: US 2002/0100045 A1
(43) Pub. Date: Jul. 25, 2002

(54) System and method for enabling anonymous personalization

(76) Inventors: Richter A. Rafey, Santa Clara, CA (US); Klaus Hofrichter, Santa Clara, CA (US); Mario Tokoro, Tokyo (JP)

Correspondence Address: OPPENHEIMER WOLFF & DONNELLY, P. O. BOX 10356, PALO ALTO, CA, 94303, US

(21) Appl. No.: 09/768,951

(22) Filed: Jan. 23, 2001

(51) Int. Cl. H04N 7/16; G06F 3/00; H04N 5/445; G06F 13/00; H04N 7/173

(52) U.S. Cl. 725/46; 725/47; 725/134; 725/1

(57) ABSTRACT

A system and method for anonymously customizing/accessing the viewing selection of interactive media services is disclosed. The system employs anonymous customization (personalization) of the media service to be used by a user based on the individual profile of a particular user. The user profile is modifiable based on the preferences/purchases/subscriptions of the user. The user profile is stored locally, thereby providing for onsite control of media services at locations.

### FIELD OF THE INVENTION

The present invention generally relates to interactive media services and devices and, more particularly, to delivery and local management of interactive media services based on user preferences which can be personalized without identifying the user to the service provider.

### BACKGROUND OF THE INVENTION

Conventional television (TV) formats and content presentation models are burdened with significant shortcomings from the perspective of both the content provider (i.e., broadcasters) and the viewer. Broadcasters typically provide a linear presentation style. That is, the content provider edits the raw material prior to broadcast into a linear, single-option presentation provided at predetermined times and intervals. Because of the limited presentation styles provided by current broadcasters, a need arises for a method of providing a media presentation style without the rigid limitations of a single and linear presentation style.

Similarly, conventional broadcasting provides essentially no services or functions with the broadcast media. Rather, broadcasting services offer only content data, such as audio/visual data. Consequently, a need arises for overcoming the limitations of audiovisual broadcasting in order to provide greater utility to the viewer.

Another problem associated with conventional broadcasting styles is the increased control that viewers have with viewing some portions of the broadcast programs. That is, broadcasters often lack control over their business plan's goal of providing exposure for a program sponsor. Home video recording devices, i.e., personal video recorders (PVR), are a prime cause for this situation. By recording programs, and by using the advertisement-skipping feature offered by some systems, the program's sponsors fail to achieve the desired exposure necessary to justify sponsorship expenses. However, even if a sponsor receives exposure, a need still arises to match a sponsor or product with an intended market audience. Hence, a need arises for a method to provide a content provider with some control over what media content the user can view.

From the viewer's perspective, they have no control over the format of the additional content provided by the broadcasters. More specifically, the programs provided by the broadcasters include advertisements and other information used to defray the costs of production. A viewer's time is often wasted by initially watching commercials, or other advertisements that the viewer is not interested in. To overcome this shortcoming, viewers often record a broadcast of interest and then subsequently skip via fast-forward, seek functions, etc., the advertisements or content the viewer is not interested in. A drawback with this approach is that the viewer still waste time and energy navigating the previously recorded broadcast.

Interactive and pay television content providers also suffer from the shortcomings provided above. Moreover, the subscriber of such services suffers from the additional drawback of having to pay for content that they have little to no control over or interest in. If there is a particular program, or type of program, that the viewer finds offensive, inappropriate, or otherwise undesirable, the viewer is responsible for manually prohibiting (i.e., blocking) such content from being available on their television sets, or other suitable display devices. Given the large number of channels available through subscription services, the time spent filtering unwanted content can become burdensome.

### SUMMARY OF THE INVENTION

The aforementioned and related drawbacks associated with conventional media content providers and presentation styles are substantially reduced or eliminated by the present invention. The present invention is directed to an interactive personalized viewing system and corresponding method for customizing the content viewed by the user. Content customization is provided by an anonymous, modifiable user profile that is locally stored within a dedicated service cartridge. The user profile outlines the viewing preferences and interests of the corresponding user. The service cartridges are configured to receive the broadcast signal frequency from a specific content provider. The service cartridges also include a local memory for storing the profile of the user, such that the content provided in the received broadcast signal can be formatted and reorganized for viewing based on the viewing preferences contained in the user profile. Each service cartridge has a unique identifier that is readable by other service cartridges, such that the user profile can be modified in accordance with the preferences or genre associated with the new service cartridge. Accordingly, the substantive content and any additional information that is viewed by the user is tailored to the particular user's preferences in an anonymous fashion.

According to an exemplary embodiment, the personalized viewing system of the present invention comprises a base station configured to provide a video signal to a display device; and an electronic media element, including a dedicated tuner for receiving a broadcast signal, the electronic media element further including a local storage element for storing at least a portion of a modifiable user profile which provides the viewing preferences of the user, and a processing element operative to generate the video signal provided by the display device by modifying the display characteristics of the broadcast signal in response to the user profile, wherein the video signal display characteristics are modified by the user profile.

According to an exemplary embodiment, the method of enabling personalized content viewing comprises the steps of creating a user profile by providing an initial set of viewing preferences; and modifying the user profile on the fly. According to an exemplary embodiment, modifying the user profile comprises the steps of detecting the unique identifier of the installed dedicated electronic media device; and adding the characteristics of the newly installed dedicated electronic media device to the user profile.

An advantage of the present invention is that the user can view customized interactive TV anywhere, as the tuner cartridges which contain the modifiable user profile are portable.

Another advantage of the present invention is that it provides the ability to customize the content to be viewed by the viewer according to the user's preferences.

A feature of the present invention is that the user profile can be leveraged and modified without providing any personal information about the viewer to content providers.

### BRIEF DESCIRPTION OF THE DRAWINGS

The aforementioned and related advantages and features of the present invention will become apparent upon reviewing the following detailed description of the invention taken in conjunction with the following figures, where like numerals represent like elements, in which:

FIG. 1 is a block diagram of an interactive viewing system including the dedicated media element employing the anonymous personalization capability according to the present invention;

FIG. 2 is a block diagram of the dedicated media element according to a first embodiment of the present invention;

FIG. 3. is a block diagram of the dedicated media element according to an alternate embodiment of the present invention;

FIGS. 4(A)-4(C) are schematic diagrams of various interactive media system configurations according to the present invention;

FIG. 5 is a diagram of a fine-grain media stream illustrating the media broadcast signal partitioned into several segments according to the present invention;

FIG. 6 is a television view generated by using the anonymous personalization capability on the interactive viewing system according to the present invention; and

FIGS. 7(A)-7(B) are flow charts illustrating the operating steps for processing the broadcast signal of FIG. 5 for display on the interactive viewing system according to the present invention.

### DETAILED DESCRIPTION OF THE INVENTION

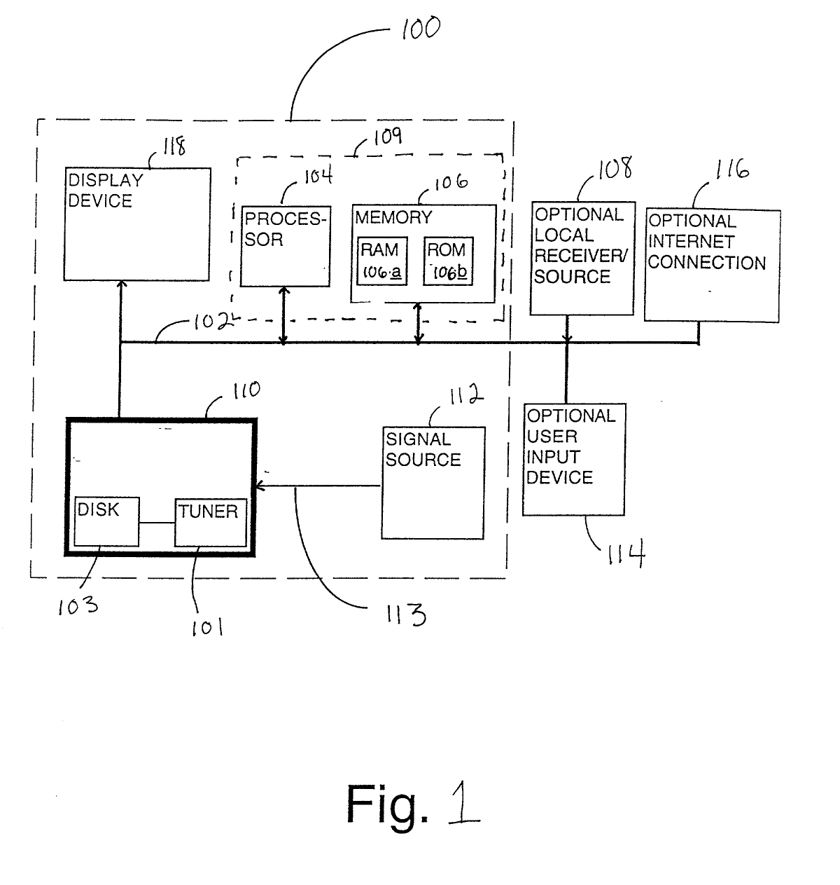

The interactive viewing system and method for anonymously customizing the images that are displayed by the viewing system will now be described with reference to FIGS. 1-7. Well known methods, procedures, components and circuits have not been described in detail so as not to unnecessarily obscure the inventive aspects of the present invention.

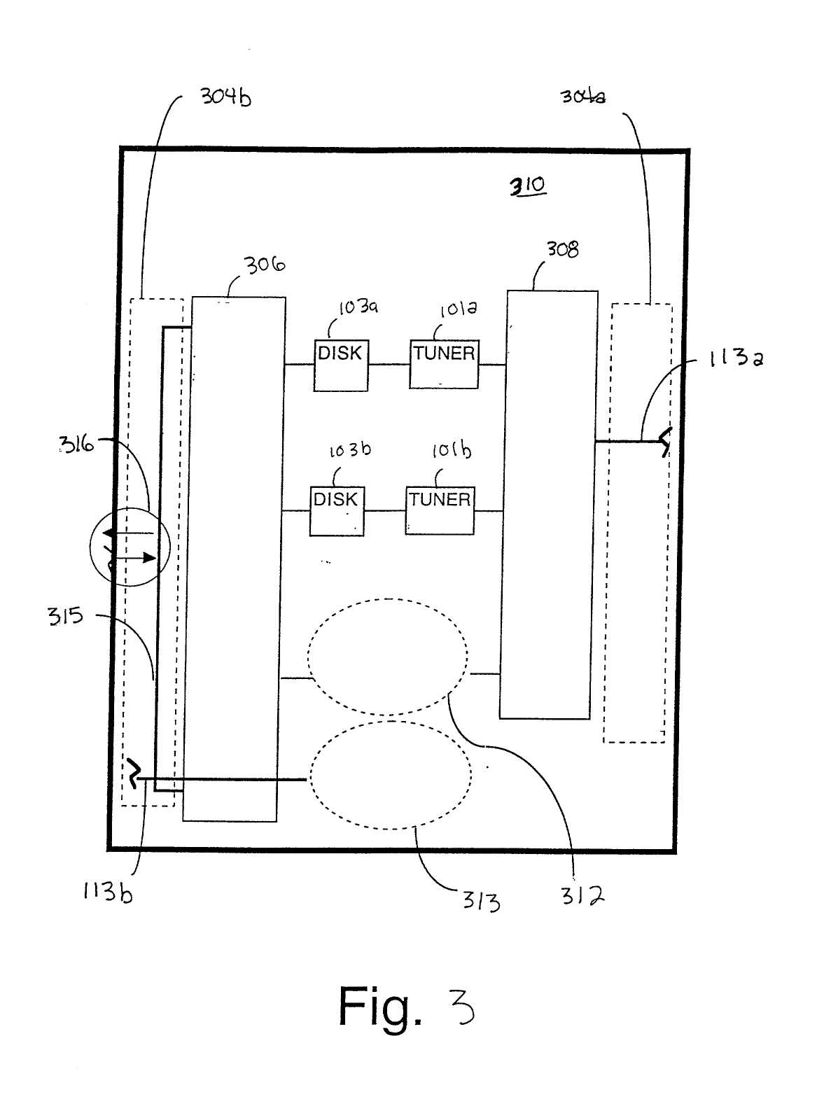

FIG. 1 is a block diagram of an interactive media system, including the dedicated media element employing the anonymous personalization capability according to the present invention. The interactive viewing system of the present invention is implemented as a Digital Television (DTV) System 100, which includes a central processing unit 104 and a memory unit 106. The central processing unit 104 processes the information and instructions that are present in the memory unit 106 and that are transmitted to the processor on bus 102. Memory unit 106 can include a random access memory (RAM) 106a, for storing temporal information and instructions for the processor 104 and a read only memory (ROM) 106b, for storing static information and instructions for the processor 104. The processor 104 and the memory unit 106 are connected via bus 102. In an exemplary embodiment of the present invention, the processor 104 and memory unit 106 comprise, and are housed within a base unit 109 (FIG. 3).

The interactive viewing system 100 also includes a display device 118 and a signal source 112. Signal source 112 can be any device, such as an antenna for receiving a broadcast signal, a cable interface for line transmissions, or a dish for receiving satellite broadcasts. Display device 118 can be any type of display, including an analog or a digital television or a personal computer (PC) display. In a preferred embodiment, the display device 118 is a digital television.

In addition to the processor 104 and the memory unit 106, the base unit 109 also includes a power converter mechanism (not shown), an optional Internet connection 116 and an optional input device 114 to other networked components within the location where the DTV 100 is located. The Internet connection 116 and communication line 117 are coupled to the processor 104 via bus 102. The Internet connection 116 and input device 114 can either be located outside the base unit 109 or can be components of the base unit 109. Also shown in FIG. 1 is an optional local receiver/source 108, which is coupled to bus 102. The local receiver/source 108 can be, for example, a set top box that provides a media signal to the processor 104 or display device 118.

The interactive viewing system also includes a modular electronic element that provides the personalized video signal to the display device 118 according to the present invention. In an exemplary embodiment, the electronic media element is a service cartridge 110 that is capable of receiving a broadcast signal from an associated content provider (i.e. broadcaster) and a storage element 103. The service cartridge 110 enables the personalized media viewing system to be implemented by providing dedicated tuning and guaranteed storage of a particular broadcast signal. A dedicated tuner 101 provides a dedicated path from the broadcast stream into the dedicated storage element 103.

Service cartridge 110 can process proprietary encoding of broadcast (or other viewing system) information in datacast associated with broadcast streams with built in support in the service cartridge for processing such broadcast information. The service cartridge 110 can also support software reconfiguration via broadcast at several different levels (e.g. device upgrade, software platform upgrade and content upgrade).

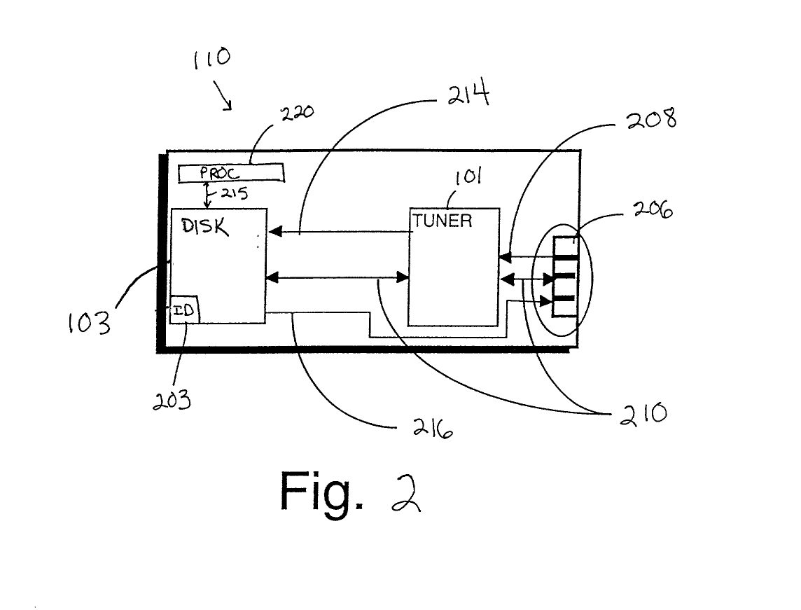

Referring now to FIG. 2, a more detailed diagram of the servicer cartridge 110 is presented. Service cartridge 110 includes a dedicated tuner 101, a media storage device 103 and a dedicated processor 220. In an exemplary embodiment, both the dedicated tuner 101 and the media storage element 103 are dedicated to a specific content provider. For example, the tuner 101 may be preset to receive a broadcast frequency corresponding to a national news broadcaster. In an alternate embodiment, the tuner 101 can be a generic tuner that is programmed with tuning instructions suitable to tune in the appropriate broadcast signal in response to a subscription service, or to some other type of business model.

The media storage element 103 can be implemented as a hard disk having an area reserved for storing the unique identifier (ID) 203 of the service cartridge 110. Each service cartridge has a unique identifier. The media storage element is also capable of storing at least a portion of a user-modifiable viewing interest profile, as will be described in greater detail below. The dedicated processor 220 is coupled to the media storage element 103 via line 215 and is capable of: (1) detecting the presence of additional tuner cartridges being provided to the viewing system via adapter 206; (2) recognizing the data present in the media storage element 103 of corresponding service cartridges; (3) manipulating and/or processing the data maintained in the media storage element 103; and (4) managing at least part of the user profile. In an exemplary embodiment, the dedicated processor 220 is programmed to re-arrange the broadcast signal stored in the media storage element 103 in accordance with the user profile stored in the memory unit 106 and the media storage element 103, respectively. Thus, it is possible for the interactive viewing system of the present invention to display all broadcast programming relating to a specific area of interest while, at the same time, storing other broadcast programming for later retrieval and viewing.

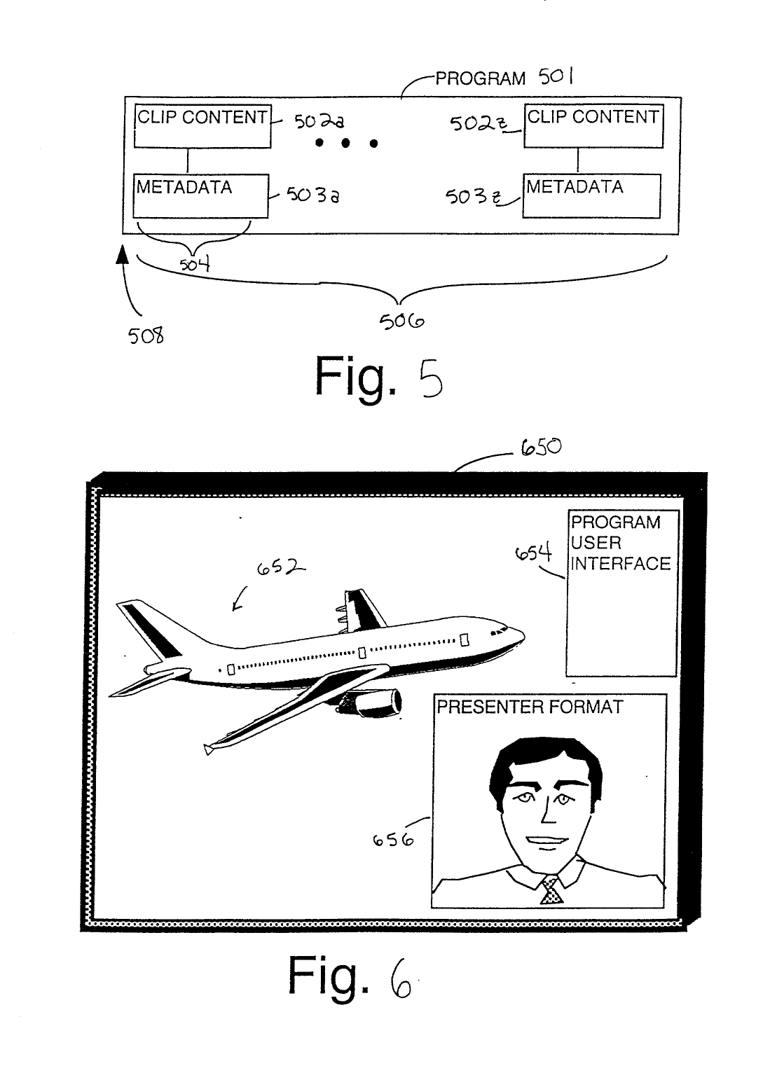

According to an exemplary embodiment of the present invention, the retrieval and viewing of the preferred programming (programming of interest to the particular user) is coordinated by matching metadata (media) information (FIG. 5) associated with the broadcast signal with the user profile stored in the storage element 103. The processed broadcast signal is then transmitted through adapter 206, via line 216, to the base unit 109 for later display on the display device 118.

Dedicated tuner 101 is coupled to adapter 206 via data line 208 to receive a broadcast signal from the signal source 112. Storage element 103 and tuner 101 are coupled via control line 210 to adapter 206 to receive instructions to tuner and/or storage element 103 in accordance with system software and commands via processor 104 and memory unit 106. Storage element 103 is also coupled to adapter 206 via line 216 to provide media data from the storage element 103 to the viewing system. Line 214 provides the dedicated media signal, tuned by the dedicated tuner 101, to dedicated media storage element 103. Adapter 206 allows the service cartridge 110 to interface with the interactive viewing system 100. In an alternate embodiment, the service cartridge 110 allows for dedicated Internet access through Internet connection 116 and, thus, eliminates the dedicated tuner 101 but retains the dedicated media storage element 103.

Although described as a modular unit comprising a single dedicated tuner-media storage pair, the service cartridge can be configured to receive, process and display broadcast signals from a plurality of content providers. FIG. 3 is a block diagram of an electronic media element according to an alternate embodiment of the present invention. As shown in FIG. 3, the alternate electronic media element is a service cartridge 310, including a media storage adapter 306, a tuner adapter 308, and interfaces 304a and 304b coupled to tuner adapter 308 and media storage adapter 306, respectively. Media storage adapter 306 includes appropriate mechanical and electrical components to accommodate a dedicated media storage device. Similarly, tuner adapter 308 includes appropriate mechanical and electrical components to accommodate a dedicated tuner. Media storage adapter 306 is coupled to tuner adapter 308 via one or more dedicated tuners, e.g. tuner 101a, and one or more dedicated storage disks 103a, respectively coupled together in exclusive pairs. In an alternate embodiment, the dedicated tuner-storage disk pairs can be implemented as a single component. In another alternate embodiment, the storage disks 103a can be implemented as a single partitioned disk.

Referring back to FIG. 3, interface 304a includes a multiplexed broadcast stream 113a coupled to the tuner adapter 308. Interface 304b includes a two-way display device control line 316, which can be coupled to media storage adapter 306 via bus 315. Bus 315 is coupled to bus 102 as illustrated in FIG. 1. Interface 304b also includes an optional Internet connection 113b that may be coupled to one or more dedicated cartridges 312 (illustrated as dotted outline). In an alternate embodiment, only a dedicated storage device 313 is coupled to the optional Internet connection 113b as the Internet connection does not need a dedicated tuner. Although shown having a single open slot 312 for supporting an additional dedicated media storage element-tuner pair, the tuner cartridge 310 can be configured to accept any number of dedicated media storage element-tuner pairs.

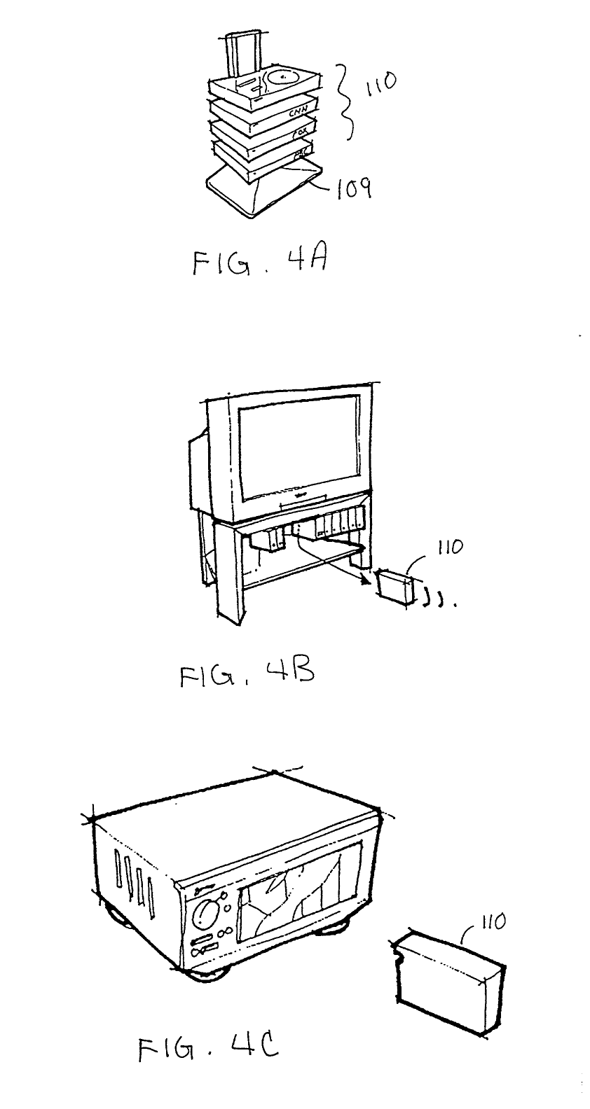

As the service cartridges employ a modular interface and are modular in design, the interactive viewing system 100 of the present invention can be physically implemented as a plug-and-play system. For example, in a preferred embodiment, the interactive viewing system of the present invention is implemented as a stacked, standalone plug-and-play DTV system as shown in FIG. 4A. As shown in FIG. 4A, the service cartridges 110 are stacked on top of the base unit 109. FIG. 4B shows an alternate implementation where the interactive system is built directly into a larger display device. FIG. 4C shows another alternate implementation of the present invention where a single service cartridge 110 is inserted into a stand-alone unit.

The broadcast signal that is processed and displayed on the display device of the corresponding viewing system will now be described with reference to FIG. 5. FIG. 5 is a diagram of a fine-grain media stream illustrating a media broadcast signal being partitioned into several clips according to the present invention. The media broadcast signal can be a news program modulated in such a fashion to be transmitted as physical block 501. Physical block 501 has a time span 506 over which the underlying news program is presented. According to the present invention, a service provider (or content provider) appends metadata 504 to the broadcast signal that partitions the broadcast signal 508 into a plurality of segments (502a-502z) based on topic. A metadata tag, identifying each of those segments, is then appended at appropriate locations along the broadcast signal. For example, metadata tag 503a can correspond to recent international news. Metadata tag 503b can correspond to the portion of the news program relating to recent sports or music developments. Additional metadata tags can be used to further partition and identify additional segments of the news program (e.g. weather, market news, etc.). According to the present invention, it is this metatag data that is used along with the user profile in determining what programming content, and the viewing order, that is viewed to the user.

The present invention is well suited to using any scale of metadata labeling, as appropriate for an application. For example, tagging segments with metadata would be appropriate for some news programs having many short clips in the program. By using the fine-grain metadata tagging approach, the present invention provides the necessary data and infrastructure allowing the interactive viewing system to provide enhanced services and functions to the viewer. One such service would be tracking and compiling purchases made by the viewer through the optional Internet connection. Another service provided by the system of the present invention is presenting target advertising in the broadcast signal based on the interest of the viewer as provided in the user profile. By targeting specific advertising to the viewer based on viewer preferences, advertisers may increase performance and market share.

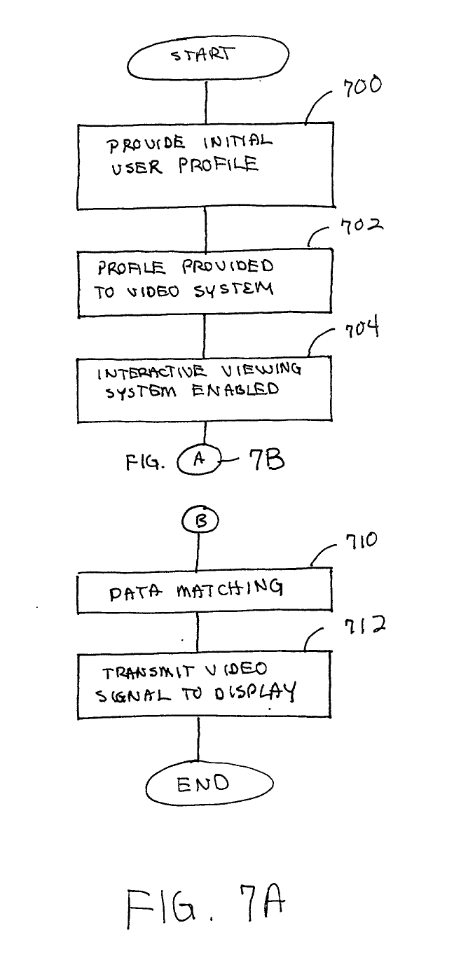

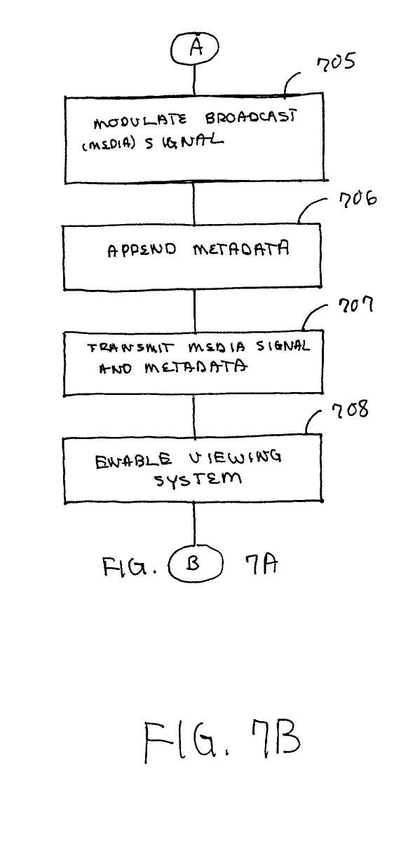

FIG. 6 shows a television view generated by the interactive viewing system according to the present invention. Television view 650 is shown on the digital TV 118 of the present invention. Program user interface 654 is provided along with a presenter image 656, both of which are overlaid onto a core media content 652, e.g. an airplane story segment. The present invention provides the appropriate audio and associated data corresponding to the video signal. Television view 650 illustrates how the broadcaster can control some of the management formatting and presentation of media to the viewer. Similarly, television view 650 illustrates how the viewer can interact with predetermined menu options to access and accomplish desired services and features, e.g. viewing program user interface for alternate clips, selecting a function from a menu in program user interface 654, or adjusting the presenter format 656. The predetermined menu options may also include an option that allows the user to access and modify their user profile. The present invention is well suited to using any combination of these, and other, presentation formats and contents to present media content to the viewer. Furthermore, each of the aforementioned interactive services and features can be implemented independent of one another, or in any combination thereof. The process steps employed to provide the interactive viewing system of the present invention will now be described with reference to FIG. 7.

FIG. 7 is a flowchart of the process steps performed to provide the personalized interactive viewing capability of the present invention. The process beings at step 700 where the viewer signs up for a subscription service, or other comparable service. As part of the subscription process, the user provides an initial viewing and interest profile. This profile outlines the substantive interests and/or viewing preferences of the viewer (i.e. music, animals, international events, etc). In step 702, the initial user profile, along with other media system program information, is transferred to the base unit 109 of the interactive viewing system and stored in the RAM 106a. After the initial user profile has been stored in the RAM 106a, the user can take the base unit or service cartridge to a location remote from where they subscribed to the service and connect it to any suitably configured display device, such as digital TV 118, or a base unit.

After joining the subscription service and connecting the base unit 109 to the digital TV 118 via line 102, the viewer is now able to receive and watch only programming content that is of interest to the viewer according to the steps provided in FIG. 7B. As shown in step 705 of FIG. 7B, appropriate metadata tags are associated to the content present in the media signal provided by the content provider. Next, in step 706, the media signal is formatted with an appropriate modulation carrier, thereby providing the broadcast signal that is transmitted to the corresponding base units for storage, processing and later viewing in step 707. The modulation and transmission of the broadcast signal to the respective base units of corresponding interactive viewing systems is described in greater detail in co-pending application Ser. No. 09/524,770, entitled “A Service Module and a Method for Providing a Dedicated On-Site Media Service”, assigned to the assignee of the present invention and incorporated fully herein. The transmitted broadcast signal enables the interactive viewing system in step 708.

Referring back to FIG. 7A, the broadcast signal is received by the signal source 112, demodulated by dedicated tuner 101 and transferred to the dedicated storage element 103. Once present in the storage element 103, the processor 104 matches the metadata tags appended to the broadcast signal against the user profile stored in the RAM 106a and the storage element 103. In an alternate embodiment, prefiltering of the broadcast signal based on the user profile is performed before the signal is transferred to the storage element 103. If no match is found, then the footage is skipped. By using the interactive viewing system of the present invention, the user only has to watch those programs that are of interest to the user. Further, aside from only watching content that is of interest to the user, the interactive viewing system of the present invention also provides the capability of watching content of interest in a specific order. Thus, the user does not have to waste valuable time manually searching for content of interest; the system automatically performs such screening.

The viewing system of the present invention also provides the capability of anonymously accessing or modifying the user profile. Such access can be implemented by the user entering profile information through the interactive menu described above, or through any suitable interactive means. In this fashion, the user profile can be accessed and modified without the service provider being made aware of the identity of the individual making the modifications.

As discussed in greater detail above, the initial user profile is stored in the of base unit 109. This base unit is connected to the digital TV 118 through a bus 102. Through the application of additional service cartridges 110 to the base unit 109, the user profile can be modified without the user having to notify the subscription provider and without the knowledge of content providers.

As discussed above in greater detail with reference to FIG. 2, each service cartridge 110 has a unique identifier that can be, for example, used to identify the broadcast signal frequency that the corresponding dedicated tuner 101 can properly receive and demodulate. This signal, in turn, carries the particular type of programming content that the particular service cartridge can tune in. For example, the service cartridge may be configured to tune in only CNN or the Discovery Channel. The presence and identity of the particular service cartridge can be communicated to the processor 104 via adapter 206. In operation, when a new service cartridge 110 is integrated into the viewing system 100, the initial user profile is transferred from the memory unit 106 to the dedicated storage element 103 of the service cartridge 110. The local processor 220 of the service cartridge then modifies the initial user profile by adding the information that is to be provided through the particular service cartridge to the user profile. This modified user profile is then stored in the dedicated storage element 103 of the new service cartridge. The modified user profile is then transferred to the memory unit 106 of the base unit 109. This modification occurs each time a new, or unrecognized, service cartridge 110 is added to the base unit stack as illustrated, for example, in FIG. 4. Thus, the most recent user profile is present within the dedicated storage element of each service cartridge.

More specifically, if the user applies a Discovery Channel tuner cartridge (or a generic service cartridge configured to receive the Discovery Channel) to the viewing system, the other service cartridges will recognize the Discovery Channel service cartridge based on the unique ID 203 stored therein. The user profile will then be modified to include recognition of the content and services provided by the Discovery Channel and any associated content provider. This is referred to as implicit personalization. The user profile is not directly modified by the user. Instead, the user profile is modified based on the user adding a new service cartridge to the viewing system cartridge stack.

Conversely, removing service cartridges from the system can also modify the user profile. For example, if a tuner cartridge has been removed from the system for a specific period, that category of interest will then be removed from the user profile.

The above detailed description of the present invention has been presented for the purposes of illustration and description. Although the present invention has been described with respect to several specific embodiments, various changes and modifications may be suggested to persons of ordinary skill in the art, and it is intended that the present invention encompass such changes and modifications as fall within the scope of the claims appended hereto.

What is claimed is:

1. An interactive personalized viewing system, comprising:
a base station configured to provide a video signal to a display device; and
an electronic media element, the electronic media element including a dedicated tuner for receiving a broadcast signal, the electronic media element further including a local storage element for storing at least a portion of a modifiable user profile which provides the viewing preferences of the user, and a processing element operative to generate the video signal provided to the display device by modifying the display characteristics of the broadcast signal in response to the user profile, wherein the video signal display characteristics are anonymously modified by the user profile.

2. The personalized viewing system of claim 1, wherein the electronic media element is a service cartridge including a detection element, the service cartridge having a unique identifier associated therewith stored in the local storage element wherein the display characteristics of the video signal are modified upon detection of the unique identifier of the service cartridge.

3. The personalized viewing system of claim 1, wherein the broadcast signal is maintained in the local memory and modified in response to the user profile before the video signal is provided to the display device.

4. The personalized viewing system of claim 3, wherein the modification of the broadcast signal comprises a reorganization of the content of the broadcast signal in response to the user profile.

5. The personalized viewing system of claim 2, wherein the user profile is accessed and modified upon detection of the unique identifier of a new service cartridge.

6. The personalized viewing system of claim 5, wherein the service cartridge further includes a plurality of dedicated tuners, each of the dedicated tuners operative to receive a specific corresponding broadcast signal.

7. The personalized viewing system of claim 6, wherein the service cartridge further includes a plurality of media storage elements operative to store a specific video signal corresponding to the plurality of tuners.

8. The personalized viewing system of claim 2, wherein the base station further includes a communication link, and the service cartridge includes means for enabling electronic purchases through the communication link, the electronic purchasing means operative to track purchases made by the user.

9. The personalized viewing system of claim 8, wherein the service cartridge includes means for modifying the user profile in response to purchases tracked by the electronic purchasing means.

10. The personalized viewing system of claim 2, wherein anonymous personalization is based on a fee service.

11. An electronic media element for enabling an interactive personalized viewing system, comprising:
a tuner dedicated to receive a broadcast signal having a predetermined frequency range;
an adapter, coupled to the tuner, operative to provide a video signal to a display device;
a local memory operative to store the broadcast signal, the local memory further storing at least a portion of a modifiable user profile and a unique identifier of the media element, the user profile including the viewing and additional preferences of the user; and
an electronic component operative to generate the video signal by modifying the characteristics of the broadcast signal in response to the user profile, wherein the video display characteristics are anonymously modified by the user profile.

12. The media element of claim 11, wherein metadata is associated to identify segments of the broadcast signal and the viewing order of the segments is reorganized in response to the user profile.

13. The media element of claim 11, wherein the reorganization of viewing segments is determined by matching the metadata with the contents of the user profile.

14. The media element of claim 12, wherein the electronic component comprises a processor capable of performing a comparison of the metadata and the data stored in the user profile.

15. The media element of claim 10, further including a plurality of tuners, each of the tuners operative to receive a broadcast signal having a predetermined frequency range, and a plurality of media storage elements operative to store the broadcast signals received by each of the plurality of tuners.

16, The media element of claim 10, further including means for detecting information present in other media elements.

17. The media element of claim 15, wherein the unique identifier is stored in the local memory, the unique identifier information being detected by the detection unit such that the use profile is modified in response to the detection of the unique identifier.

18. The media element of claim 16, wherein the user profile is modified based on the information present in the newly detected media element.

19. A method of enabling anonymous personalization of an interactive viewing system, comprising the steps of:
(a) creating a user profile by providing an initial set of viewing preferences;
(b) modifying the user profile created in step (a) through the installation of a new dedicated electronic media device into the viewing system.

20. The method of claim 18, wherein the dedicated electronic media device of step (b) includes a unique identifier stored therein which automatically modifies the user profile based on the information contained therein.

21. The method of claim 19, wherein modifying the user profile comprises the steps of:
(b1) detecting the unique identifier of the installed dedicated electronic media device; and
(b2) adding the characteristics of the dedicated electronic media device identified in step (b1) to the user profile.
